(19) United States
(12) Patent Application Publication
(10) Pub. No.: US 2010/0246828 A1
(43) Pub. Date: Sep. 30, 2010

(54) METHOD AND SYSTEM OF PARALLELIZED DATA DECRYPTION AND KEY GENERATION

(76) Inventor: David Johnston, Beaverton, OR (US)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/414,359

(22) Filed: Mar. 30, 2009

(51) Int. Cl. H04L 9/08; H04L 9/28

(52) U.S. Cl. 380/278; 380/45; 380/28

(57) ABSTRACT

A method and system to decrypt data in a particular round of decryption substantially in parallel with the generation of a decryption key associated with the next round of the particular round of decryption. By performing an inverse next key computation, the decryption process can be symmetric to the advanced encryption standard (AES) encryption process in terms of processing time, hardware implementation and storage requirements.

### FIELD OF THE INVENTION

This invention relates to data decryption, and more specifically but not exclusively, to decrypting data in a particular round of decryption substantially in parallel with the generation of a decryption key associated with the next round of the particular round of decryption.

### BACKGROUND DESCRIPTION

The advanced encryption standard (AES) is one of several cryptographic algorithms and is used in wireless protocols such as the Institute of Electrical and Electronics Engineers (IEEE) 802.11 wireless local area network (WLAN) standards and in application such as secure file transfer protocol. FIG. 1 shows a prior art encryption and decryption process 100. The encryption engine 110 and decryption engine 130 use the same encryption key 115 and the same cryptographic algorithm such as the AES to encrypt the data 120 or to decrypt the encrypted data 125.

FIG. 2 illustrates a prior art AES encryption process 200. In step 205, round 1 of encryption encrypts the data 120 using the encryption key 115 to create a first intermediate data. In step 210, the next key computation 1 generates the key associated with round 2 of encryption based on the encryption key 115. Typically, the steps 205 and 210 are performed substantially in parallel to optimize process 200. When steps 205 and 210 are completed, round 2 of encryption in step 215 encrypts the first intermediate data using the key generated from step 210 to create a second intermediate data. The steps 220, 225, 230, 255, 260, and 265 are similar to the operations described herein and shall not be repeated. Process 200 ends when the encrypted data 125 is created after round n of encryption is completed in step 265.

FIG. 3 shows the prior art AES decryption process 300. Unlike the AES encryption process 200, the AES decryption process 300 requires all the respective keys associated with the respective rounds of decryption to be generated and stored before the AES decryption process 300 can begin. In step 302, the key associated with round n of decryption is stored. In step 310, the next key computation 1 generates the key associated with round n−1 of decryption based on the encryption key 115 and step 312 stores the key associated with round n−1 of decryption after step 310 is completed. The steps 320, 322, 330, 332, 340 and 342 are similar to the operations described herein and shall not be repeated. In step 302, round 1 of decryption decrypts the encrypted data 125 using the stored key associated with round 1 of decryption to create a first intermediate data. Steps 305, 315, 325 and 335 show the subsequent rounds of decryption until the data 120 is created.

The AES decryption process 300 is not optimal compared to the AES encryption process 200. This is because all the respective keys associated with the respective rounds of decryption are required to be stored in memory or registers before the AES decryption process 300 can occur. For example, for 10 rounds of AES decryption with a key length of 128 bits, 1280 bits (10 keys multiplied by 128 bits) have to be stored and multiplexed for decryption. On the other hand, the AES encryption process 200 requires only 128 bits to store the encryption key. In addition, the AES decryption process 300 is asymmetric as it requires more hardware to implement and has a different sequencing from the AES encryption process 200.

### BRIEF DESCRIPTION OF THE DRAWINGS

The features and advantages of embodiments of the invention will become apparent from the following detailed description of the subject matter in which:

FIG. 1 illustrates a prior art encryption and decryption process;

FIG. 2 illustrates a prior art AES encryption process;

FIG. 3 illustrates a prior art AES decryption process;

FIG. 4 illustrates a decryption process in accordance with one embodiment of the invention;

FIG. 5 illustrates a key schedule in accordance with one embodiment of the invention;

FIG. 6 illustrates a flowchart of the inverse next key computation in accordance with one embodiment of the invention;

FIG. 7 illustrates a code in C language to implement the inverse next key computation in accordance with one embodiment of the invention;

FIG. 8 illustrates a block diagram of a cryptographic processor in accordance with one embodiment of the invention; and

FIG. 9 illustrates a block diagram of a system to implement the methods disclosed herein according with one embodiment of the invention.

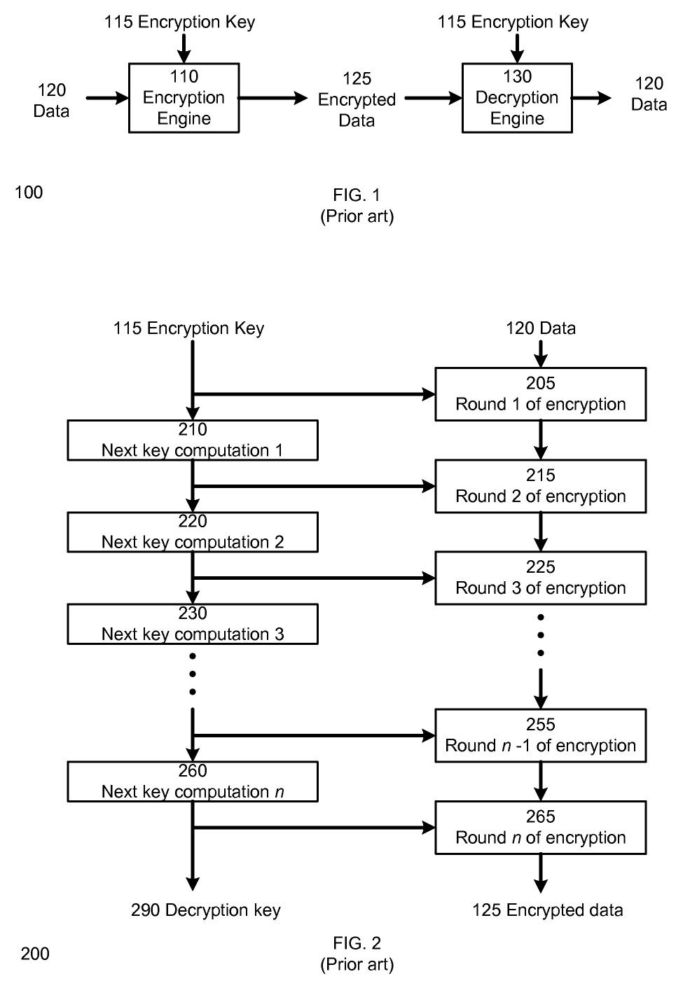

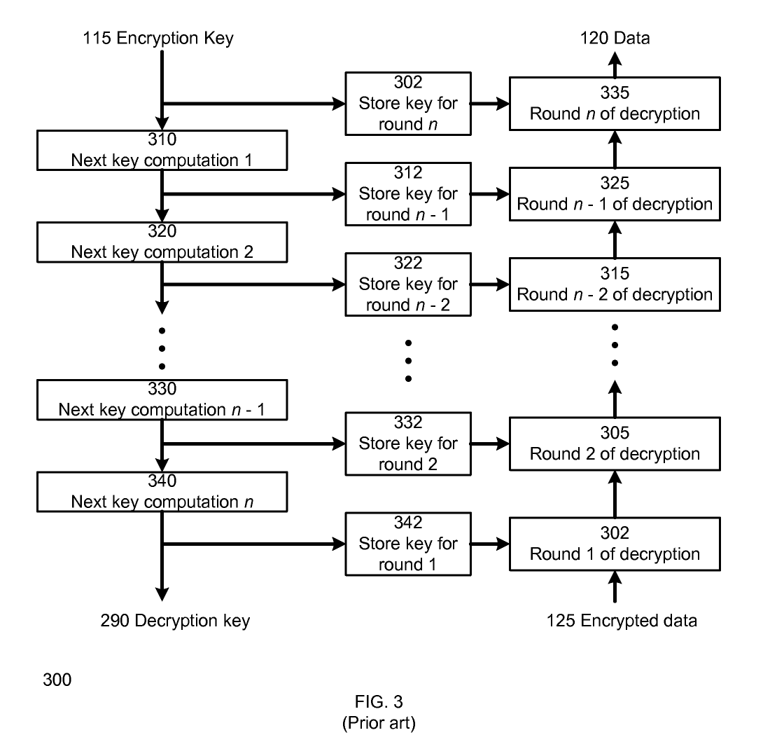

### DETAILED DESCRIPTION

Reference in the specification to “one embodiment” or “an embodiment” of the invention means that a particular feature, structure or characteristic described in connection with the embodiment is included in at least one embodiment of the invention. Thus, the appearances of the phrase “in one embodiment” appearing in various places throughout the specification are not necessarily all referring to the same embodiment.

Embodiments of the invention provide a method and system to allow the decrypting of data in a particular round of decryption substantially in parallel with the generation of a decryption key associated with the next round of the particular round of decryption. In one embodiment of the invention, the decryption is operable in accordance with the AES.

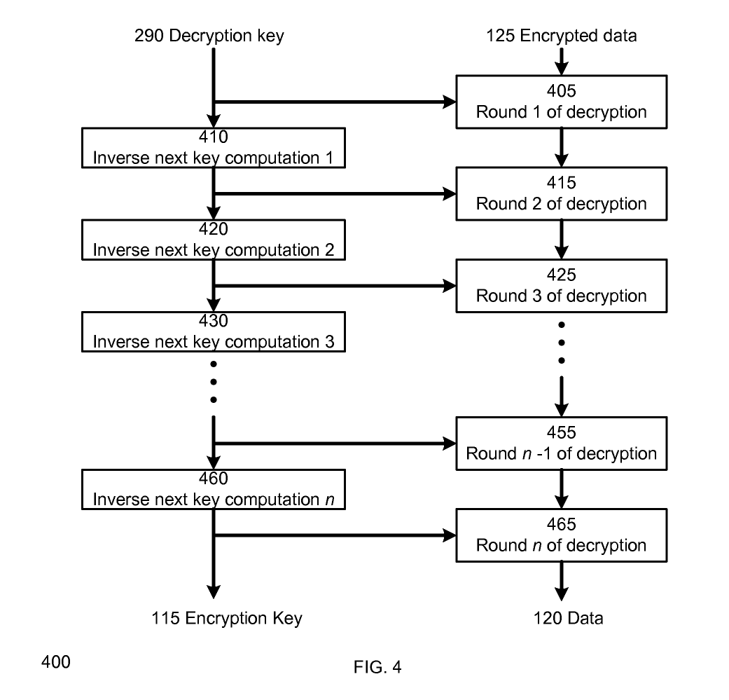

FIG. 4 illustrates a decryption process 400 in accordance with one embodiment of the invention. The decryption process 400 uses the decryption key 290 instead of the encryption key 115 as the input for key generation. In step 405, round 1 of decryption decrypts encrypted data 125 using the decryption key 290 associated with round 1 of decryption to create a first intermediate data. In step 410, the inverse next key computation 1 generates the key associated with round 2 of decryption based on the received decryption key 290. In one embodiment of the invention, the step 405 of performing round 1 of decryption using the received decryption key 290 is performed substantially in parallel with the step 410 of generating the key associated with round 2 of decryption based on the decryption key 290.

After steps 405 and 410 are completed, round 2 of decryption in step 415 decrypts the first intermediate data from step 405 using the generated key associated with round 2 of decryption to create a second intermediate data. In step 420, the inverse next key computation 2 generates the key associated with round 3 of decryption based on the generated key associated with round 2 of decryption. Similarly, the step 415 of performing round 2 of decryption using the generated key associated with round 2 of decryption is performed substantially in parallel with the step 420 of generating the key associated with round 3 of decryption based on the generated key associated with round 2 of decryption.

The steps 425, 430, 455, 460, and 465 are similarly to the operations described herein and shall not be repeated herein. The decryption process 400 ends when the data 120 is obtained after round n of decryption is completed. The number n represents the number of rounds of encryption. In one embodiment of the invention, n is set to 10, 12 or 14 when the key length of the encryption key 115 is 128, 192, or 256 bits respectively, in accordance with the AES. The data 120 includes, but is not limited to, clear text, encrypted data, or any other form of machine readable information.

By performing an inverse next key computation, the decryption process 400 can be symmetric to the prior art AES encryption process 200 in terms of processing time, hardware implementation and storage requirements. In one embodiment of the invention, the decryption key 290 associated with round 1 of decryption is stored in a buffer. The keys associated with the other rounds of decryption are not stored in the buffer. The respective key associated with a respective round of decryption is generated by the next key computation as shown in steps 410, 420, 430 and 460 and each respective round of decryption can use its generated key without storing the generated key (except round 1 of decryption as round 1 uses the stored decryption key 290).

In another embodiment of the invention, only one key associated with a particular round of decryption is required to be stored between each round of decryption. For example, the decryption key 290 associated with round 1 of decryption can be stored in a buffer after it is received. Round 1 of decryption decrypts the encrypted data 125 using the decryption key 290 stored in the buffer to create a first intermediate data in step 405. After the key associated with round 2 of decryption is generated by step 410 of inverse next key computation 1 and after round 1 of decryption is completed, the buffer can be overwritten with the key associated with round 2 of decryption. Round 2 of decryption decrypts the first intermediate data using the key associated with round 2 of decryption stored in the buffer to create a second intermediate data in step 415. The same buffer is used to store the current key for each current round of decryption.

The buffer includes, but is not limited to, a memory storage area, a cache memory, a secure flash memory, or any other forms of data storage media. In embodiments of the invention, the key storage requirements are reduced significantly compared to the prior art AES decryption process 300. For example, to perform decryption with a key length of 128 bits, the prior art AES decryption process 300 requires 1280 bits (10 keys multiplied by 128 bits) to be stored before decryption can begin. Embodiments of the invention, on the other hand, require just 128 bits to store the decryption key 290. The reduction in key storage requirements can offer a cost advantage as lesser area on the chip implementation is required.

Embodiments of the invention also has a faster processing time compared to the prior art AES decryption process 300 as the decrypting of data in a particular round of decryption is performed substantially in parallel with the generation of a decryption key associated with the next round of the particular round of decryption. The prior art AES decryption process 300 incurs extra time compared to embodiments of the invention as the all the respective keys associated with the respective rounds of decryption need to be generated before decryption can occur. For example, for 10 rounds of decryption with a key length of 128 bits and assuming that generating a key and performing a round of decryption each require a machine cycle, the prior art AES decryption process 300 requires 10 machine cycles to generate all the keys and another 10 machine cycles to perform 10 rounds of decryption. Embodiments of the invention, on the other hand, require just 10 machine cycles to perform 10 rounds of decryption as the respective keys in the key schedule are generated substantially in parallel with the decryption rounds.

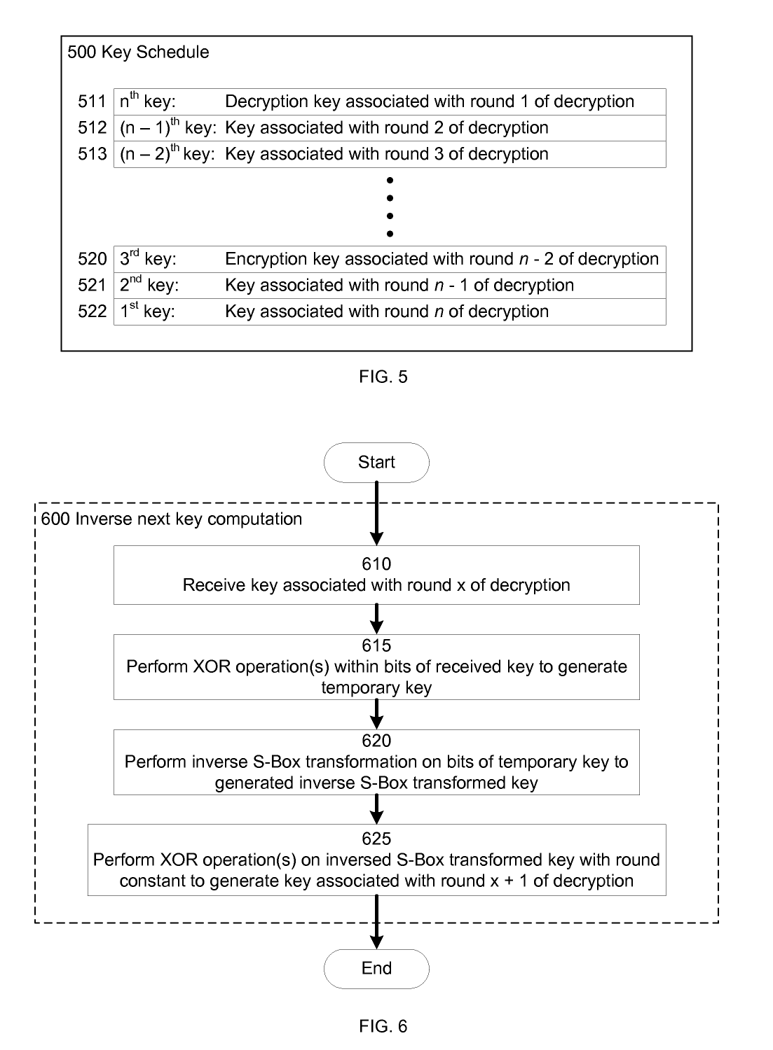

FIG. 5 illustrates a key schedule 500 in accordance with one embodiment of the invention. The key schedule 500 is an array of the respective keys associated with the respective rounds of decryption and the keys in the key schedule 500 are generated in a reverse order. For example, in one embodiment of the invention, the n^{th} key 511 or the last key in the key schedule 500 associated with round 1 of decryption is the decryption key 290. The (n−1)^{th} key 512 or the penultimate key in the key schedule 500 associated with round 2 of decryption is generated by step 410 of inverse next key computation 1. Similarly, the (n−2)^{th} key 513 in the key schedule 500 associated with round 3 of decryption is generated by step 420 of inverse next key computation 2.

The generation in reverse order of the keys in the key schedule 500 continues until the first key 522 in the key schedule 500 associated with round n of the decryption is generated. Elements 520 and 521 show the third and second key in the key schedule 500 associated with round n−2 and round n−1 of decryption respectively. When the key schedule 500 is generated in a reverse order, it allows the decryption process 400 to decrypt data in a particular round of decryption substantially in parallel with the generation of a decryption key associated with the next round of the particular round of decryption.

FIG. 6 illustrates a flowchart 600 of the inverse next key computation in accordance with one embodiment of the invention. The flowchart 600 shows the inverse next key computation steps of 410, 420, 430, and 460 of FIG. 4 in one embodiment of the invention. In step 610, the key associated with round x of decryption is received. The number x represents any integer number between 1 and n−1 and the number x is excluded from the number n as the inverse next key computation of the key associated with round n−1 generates the key associated with round n of decryption based on the key associated with round n−1 of decryption. For example, in 10 rounds of decryption, the inverse next key computation of the key associated with 9 generates the key associated with round 10 of decryption based on the key associated with round 9 of decryption.

In step 610, one or more exclusive OR (EXOR) operations is/are performed within bits of the received key associated with round x of decryption to generate a temporary key. One or more inverse byte substitution transformations (inverse S-box) of bits of the temporary key is/are performed in step 620 to generate an inverse byte substituted transformed key. In step 625, one or more EXOR operations of bits of the inverse byte substituted transformed key with a round constant is/are performed to generate the key associated with round x+1 of decryption.

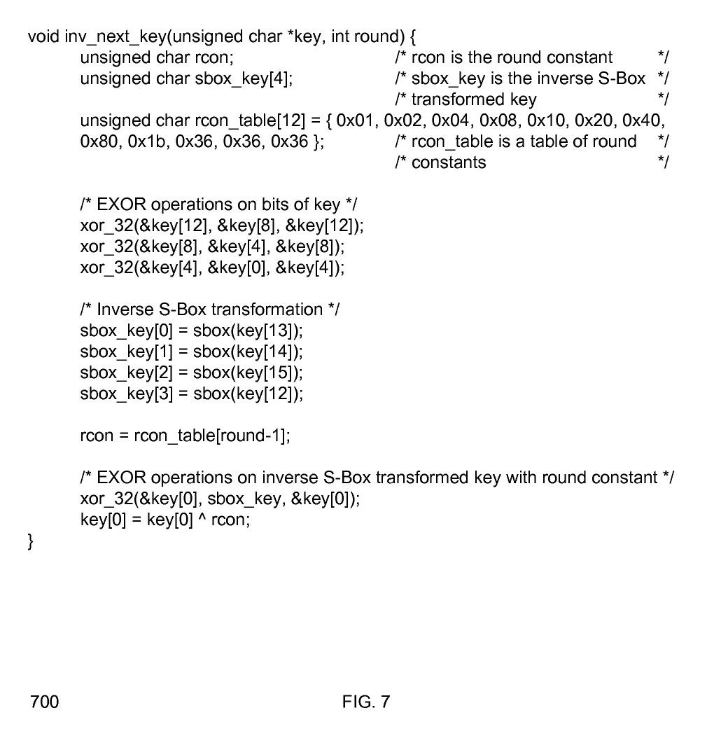

FIG. 7 illustrates a code 700 in C language to implement the inverse next key computation in accordance with one embodiment of the invention. The detailed workings of the code 700 is not explained as it is apparent to one of ordinary skilled in the relevant art how the code can function to implement the inverse next key computation. The code 700 is shown as an illustration and is not to be construed as a limitation. Additional steps or functions can be added to the code 700 without affecting the workings of the invention. Similarly, the order of the operations shown in code 700 and flowchart 600 can be changed without affecting the operation of the embodiments of the invention.

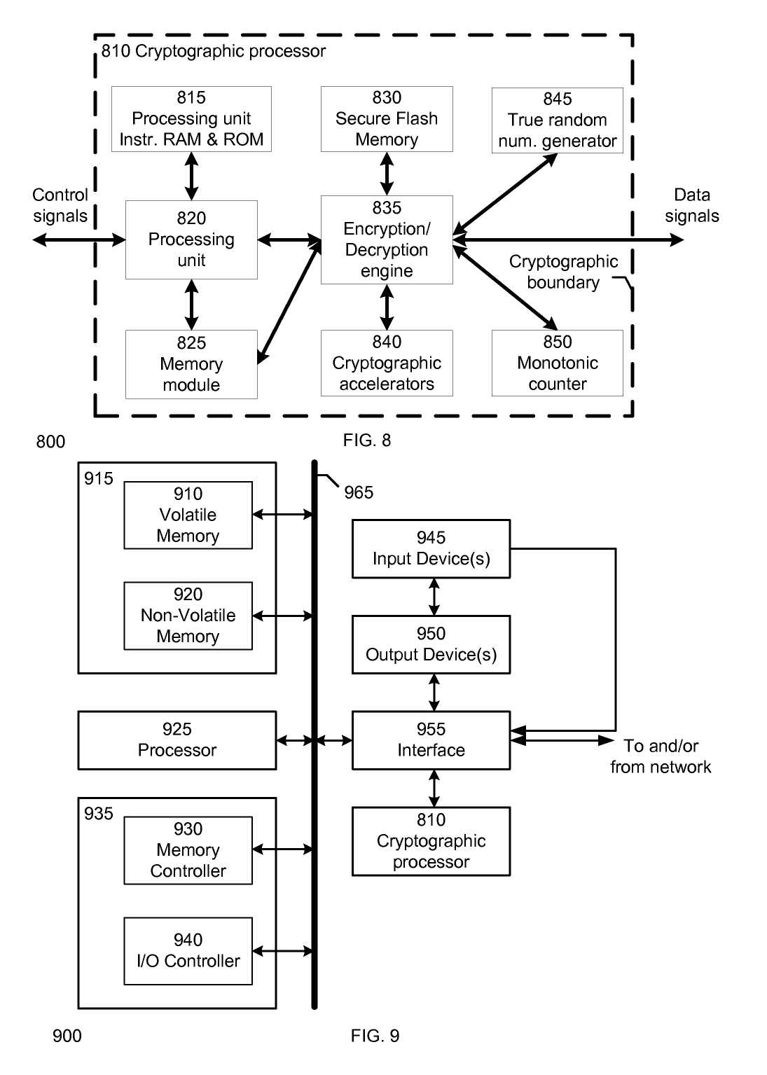

FIG. 8 illustrates a block diagram 800 of a cryptographic processor 810 in accordance with one embodiment of the invention. The cryptographic processor 810 has a well defined cryptographic boundary that is compliant with the FIPS publication 140-2, “Security requirements for cryptographic modules security requirements for cryptographic modules”, NIST, published on May 25, 2001. The cryptographic processor 810 has 7 modules, namely, the processing unit 820, the processing unit instruction read access memory (RAM) and read only memory (ROM) 815, the memory module 825, the encryption/decryption engine 835, the secure flash module 830, the cryptographic accelerators module 840, the monotonic counter 850, and the true random number generator module 845.

The processing unit 820 is accessible by bi-directional control signals outside the cryptographic boundary and bi-directional data signals are received via the encryption/decryption engine 835. The cipher keys of the encryption/decryption engine 835 are stored in the tamper resistant secure flash memory module 830. The true random number generation module 845 provides a true random number based on physical entropy to the encryption/decryption engine 835. The true random number can be used as an input for key generation algorithms or for any other cryptographic or data security related function requiring random numbers. The processing unit 815 executes instructions in the processing unit instruction RAM and ROM 815. The encryption/decryption engine 835 is connected to a cryptographic accelerators module 840 containing but not limited to, public key cryptographic accelerators, cryptographic hash accelerators, and block and stream cipher accelerators. The encryption/decryption engine 835 is also connected to the memory module 825 for buffering of data and to the monotonic counter 850 that can be used to prevent replay attacks.

Although FIG. 8 illustrates a cryptographic processor 810 with a well-defined cryptographic boundary, embodiments of the invention may also be integrated into platforms that utilize encryption or decryption. The platform includes, but is not limited to, a desktop computer, a laptop computer, a notebook computer, a personal digital assistant (PDA), a server, a workstation, a cellular telephone, a mobile computing device, an Internet appliance or any other type of computing device that uses encryption or decryption. Embodiments of the invention may also be utilized in a communication protocol such as, but is not limited to, IEEE 802.11 family of WLAN standard such as IEEE802.11n, Bluetooth, Ultra wide band, and any other communication protocol that requires encryption and decryption.

FIG. 9 illustrates a block diagram of a system 900 to implement the methods disclosed herein according with one embodiment of the invention. The system 900 includes but is not limited to, a desktop computer, a laptop computer, a notebook computer, a personal digital assistant (PDA), a server, a workstation, a cellular telephone, a mobile computing device, an Internet appliance or any other type of computing device. In another embodiment, the system 900 used to implement the methods disclosed herein may be a system on a chip (SOC) system.

The system 900 includes a chipset 935 with a memory controller 930 and an input/output (I/O) controller 940. A chipset typically provides memory and I/O management functions, as well as a plurality of general purpose and/or special purpose registers, timers, etc. that are accessible or used by the processor 925. The processor 925 may be implemented using one or more processors.

The memory controller 930 performs functions that enable the processor 925 to access and communicate with a main memory 915 that includes a volatile memory 910 and a non-volatile memory 920 via a bus 965. The volatile memory 910 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. The non-volatile memory 920 includes, but is not limited by, flash memory, ROM, EEPROM, and/or any other desired type of memory device.

Memory 915 stores information and instructions to be executed by the processor 925. Memory 915 may also store temporary variables or other intermediate information while the processor 925 is executing instructions. The system 900 includes, but is not limited to, an interface circuit 955 that is coupled with bus 965. The interface circuit 955 is implemented using any type of well known interface standard including, but is not limited to, an Ethernet interface, a universal serial bus (USB), a third generation input/output interface (3GIO) interface, and/or any other suitable type of interface.

One or more input devices 945 are connected to the interface circuit 955. The input device(s) 945 permit a user to enter data and commands into the processor 925. For example, the input device(s) 945 is implemented using, but is not limited to, a keyboard, a mouse, a touch-sensitive display, a track pad, a track ball, and/or a voice recognition system.

One or more output devices 950 connect to the interface circuit 955. For example, the output device(s) 550 are implemented using, but are not limited to, light emitting displays (LEDs), liquid crystal displays (LCDs), cathode ray tube (CRT) displays, printers and/or speakers). The interface circuit 955 includes a graphics driver card. The system 900 also includes one or more cryptographic processors 810 to encrypt or decrypt data.

The interface circuit 955 includes a communication device such as a modem or a network interface card to facilitate exchange of data with external computers via a network. The communication link between the system 900 and the network may be any type of network connection such as an Ethernet connection, a digital subscriber line (DSL), a telephone line, a cellular telephone system, a coaxial cable, etc.

Access to the input device(s) 945, the output device(s) 950, and/or the network is typically controlled by the I/O controller 940 in a conventional manner. In particular, the I/O controller 940 performs functions that enable the processor 925 to communicate with the input device(s) 945, the output device(s) 950, and/or the network via the bus 965 and the interface circuit 955.

While the components shown in FIG. 9 are depicted as separate blocks within the system 900, the functions performed by some of these blocks may be integrated within a single semiconductor circuit or may be implemented using two or more separate integrated circuits. For example, although the memory controller 930 and the I/O controller 940 are depicted as separate blocks within the chipset 935, one of ordinary skill in the relevant art will readily appreciate that the memory controller 930 and the I/O controller 940 may be integrated within a single semiconductor circuit.

Although examples of the embodiments of the disclosed subject matter are described, one of ordinary skill in the relevant art will readily appreciate that many other methods of implementing the disclosed subject matter may alternatively be used. In the preceding description, various aspects of the disclosed subject matter have been described. For purposes of explanation, specific numbers, systems and configurations were set forth in order to provide a thorough understanding of the subject matter. However, it is apparent to one skilled in the relevant art having the benefit of this disclosure that the subject matter may be practiced without the specific details. In other instances, well-known features, components, or modules were omitted, simplified, combined, or split in order not to obscure the disclosed subject matter.

The term “substantially in parallel” used herein refers to an event where two or more operations are performed simultaneously. The two or more operations do not have to start at the same time or end at the same time as long as there is an overlap period of time where the two or more operations are happening simultaneously. The term “is operable” used herein means that the device, system, protocol etc, is able to operate or is adapted to operate for its desired functionality when the device or system is in off-powered state.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

The techniques shown in the figures can be implemented using code and data stored and executed on one or more computing devices such as general purpose computers or computing devices. Such computing devices store and communicate (internally and with other computing devices over a network) code and data using machine-readable media, such as machine readable storage media (e.g., magnetic disks; optical disks; random access memory; read only memory; flash memory devices; phase-change memory) and machine readable communication media (e.g., electrical, optical, acoustical or other form of propagated signals such as carrier waves, infrared signals, digital signals, etc.).

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

What is claimed is:

1. A method comprising:
receiving a key associated with a round of decryption;
generating another key associated with a next round of decryption based at least in part on the received key; and
performing the round of decryption using the received key substantially in parallel with the generation of the another key associated with the next round of decryption, wherein the round and the next round of decryption is operable in accordance with an advanced encryption standard (AES).

2. The method of claim 1, wherein the received key is a last key of a plurality of keys in a key schedule, wherein the another key is a penultimate key of the plurality of keys in the key schedule.

3. The method of claim 2, wherein the round of decryption is a first round of a plurality of rounds of decryption and wherein the next round of decryption is a second round of the plurality of rounds of decryption.

4. The method of claim 1, further comprising:
storing in a buffer, the received key associated with the round of decryption; and
overwriting the buffer with the another key associated with the next round of decryption responsive to generating the another key and performing the round of decryption.

5. The method of claim 1, wherein generating the another key associated with the next round of decryption comprises:
performing at least one exclusive OR (EXOR) operation within bits of the received key to generate a temporary key;
performing at least one inverse byte substitution transformation (inverse S-box) of bits of the temporary key to generate an inverse byte substituted transformed key; and
performing at least one EXOR operation of bits of the inverse byte substituted transformed key with a round constant to generate the another key associated with the next round of decryption.

6. A decryption method comprising:
receiving an encrypted data and a key associated with a first round of a plurality of rounds of decryption;
generating respective keys associated with other rounds of the plurality of decryption using an inverse next key computation based at least on the received key; and
performing each of the plurality of rounds of decryption on the encrypted data without storing more than any two keys associated with the plurality of rounds of decryption.

7. The method of claim 6, wherein each round of decryption is operable in accordance with advanced encryption standard (AES).

8. The method of claim 7, wherein the received key is a last key in an encryption key schedule associated with the encrypted data.

9. The method of claim 8, wherein the received key and the generated respective keys associated with the other rounds of the plurality of decryption are keys in a decryption key schedule, and wherein the received key is a last key in the decryption key schedule.

10. The method of claim 6, wherein performing each of the plurality of rounds of decryption on the encrypted data without storing more than any two keys associated with the plurality of rounds of decryption comprises:
storing the received key in a buffer; and
overwriting the buffer with one of the generated respective keys associated with the other rounds of the plurality of decryption.

11. The method of claim 6, wherein at least one decryption round is performed in parallel with the generation of the respective keys associated with the other rounds of the plurality of decryption.

12. The method of claim 9, wherein the inverse next key computation based at least on the received key comprises:
performing at least one exclusive OR (EXOR) operation within bits of the received key to generate a temporary key;
performing at least one inverse byte substitution transformation (inverse S-box) of bits of the temporary key to generate an inverse byte substituted transformed key; and
performing at least one EXOR operation of bits of the inverse byte substituted transformed key with a round constant to generate a penultimate key in the decryption key schedule.

13. An apparatus comprising:
a single key storage element; and
an advanced encryption standard (AES) decryption engine coupled with the single key storage element to:
store a key associated with a round of decryption in the single key storage element;
generate another key associated with a next round of decryption based at least in part on the stored key;
perform the round of decryption using the stored key; and
overwrite the stored key in the single key storage element with the generated another key after performing the round of decryption.

14. The apparatus of claim 13, wherein the single key storage element is part of the AES decryption engine.

15. The apparatus of claim 14, wherein the AES decryption engine is further to receive the key associated with the round of decryption.

16. The apparatus of claim 15, wherein the received key is a last key in an encryption key schedule associated with an encrypted data to be decrypted by the AES decryption engine.

17. The apparatus of claim 13, wherein the AES decryption engine to generate the another key is to:
perform at least one exclusive OR (EXOR) operation within bits of the stored key to generate a temporary key;
perform at least one inverse byte substitution transformation (inverse S-box) of bits of the temporary key to generate an inverse byte substituted transformed key; and
perform at least one EXOR operation of bits of the inverse byte substituted transformed key with a round constant to generate the another key.

18. The apparatus of claim 13, wherein the apparatus is one of a wireless receiver operable in accordance with Institute of Electrical and Electronics Engineers (IEEE) wireless standard, of a cryptographic processor, of a communication device, and of a central processing unit (CPU).
